(19) United States
(12) Patent Application Publication
(10) Pub. No.: US 2026/0214428 A1
(43) Pub. Date: Jul. 23, 2026

(54) Marine Radio with Satellite Distress Alert Beacon

(71) Applicant: Daniel A. Katz, Kiryat Ono (IL)

(72) Inventor: Daniel A. Katz, Kiryat Ono (IL)

(21) Appl. No.: 19/034,685

(22) Filed: Jan. 23, 2025

(51) Int. Cl. H04W 4/90; H04W 64/00; H04W 84/06

(52) U.S. Cl. CPC H04W 4/90; H04W 64/00; H04W 84/06

(57) ABSTRACT

The present invention discloses a two-way radio, typically a marine VHF radio, integrating a satellite distress alert transmitter, sharing much of the radio hardware with the satellite transmitter, while enabling good functionality of both, for search and rescue of people in distress.

### BACKGROUND OF THE INVENTION

Field of the Invention: The present invention relates to two-way communication systems and, more particularly, to a marine radio with an integrated satellite distress alert beacon designed to enhance safety for people in emergency situations. The present invention is not limited to marine radios, but is also well applicable to terrestrial and airborne two-way radios.

Marine vessels operating in remote areas often face risks of accidents, technical failures, or human errors that might lead to distress situations. Presently, in most marine vessels worldwide, the only means to communicate a distress situation is a VHF radio, operating on 156-174 MHz, designated by the International Telecommunication Union (ITU) as the VHF maritime mobile band. Typically, a VHF marine radio can communicate distress alerts on voice, or data messages, using standard communication protocols such as Digital Selective Calling (DSC) or Automatic Identification System (AIS). Conveniently, there is no airtime fee for using two-way radios, particularly the VHF marine radios, however, the communication range of these radios is typically restricted to some tens of nautical miles. Therefore, in many distress situations at sea, a VHF radio, even featuring DSC or AIS, could fail to deliver a distress alert.

It is therefore an object of the present invention to enable delivering a distress alert, triggering rescue, from a two-way radio placed anywhere at sea or on land.

Satellite-based communication systems, including distress alert beacons, have been employed to overcome the range limitation by transmitting distress signals relayed by satellites, ensuring global coverage even in the most isolated regions. There are some initiatives to detect AIS messages by satellites, and relay these messages to longer distances; there are also satellite communication systems, such as Iridium and Inmarsat, enabling delivering distress alerts worldwide. Recently, Apple launched a satellite distress service, applicable to the newest iPhone mobile phone models, utilizing the Globalstart satellite system. However, all these satellite services are associated with payment, either fix or per transmission, and that discourages most of the sailors, especially fishermen and leisure sailors. Consequently, safety at sea is compromised.

It is then another object of the present invention to enable delivering a distress alert, triggering rescue, using low budget radios and subject to no service/airtime fee.

Advantageously, there is a very efficient search and rescue satellite system, named Cospas-Sarsat, providing a free of charge service of communicating distress alerts, from anywhere at sea and on land, to government rescue coordination centers.

The International Cospas-Sarsat Programme is a satellite-aided search and rescue (SAR) initiative. It is organized as a treaty-based, nonprofit, intergovernmental, humanitarian cooperative of 45 nations and agencies. It is dedicated to detecting and locating emergency locator radio beacons activated by persons, aircraft or vessels in distress, and forwarding this alert information to authorities that can take action for rescue. Member countries support the distribution of distress alerts using a constellation of around 65 satellites orbiting the Earth which carry transponders and signal processors capable of locating an emergency beacon anywhere on Earth transmitting on the Cospas-Sarsat frequency of 406 MHz.

Distress alerts are detected, located and forwarded to over 200 countries and territories at no cost to beacon owners or the receiving government agencies. Cospas-Sarsat was conceived and initiated by Canada, France, the United States, and the former Soviet Union in 1979. The first rescue using the technology of Cospas-Sarsat occurred on 10 Sep. 1982, and by now, 42 years after, the Cospas-Sarsat search and rescue system was instrumental in rescuing more than 60,000 people, worldwide.

It is also an object of the present invention to enable efficient integration of a 406 MHz Cospas-Sarsat beacon/transmitter in a marine VHF radio, as well as in terrestrial and airborne radios.

However, most of the Cospas-Sarsat beacons are independent devices requiring separate activation and operation. Thus, there is a need for an integrated communication system that combines the features of a marine radio and a satellite distress alert beacon, allowing for a streamlined, efficient method of distress signaling and communication in emergency situations. Thus, it is an object of the present invention to enable an integrated device, efficiently embedding a Cospas-Sarsat distress alert transmitter in a two-way radio.

Some satellite services that could potentially be used for communication of distress alerts, require a directional antenna at the terminal. Such is the Apple's iPhone, and the Starlink terminal, provided by the American aerospace company SpaceX. A directional antenna has typically a higher gain than an omnidirectional antenna, so can address a more challenging link budget, however being directional, limiting a mobile service, so inconvenient for maritime use, especially in distress situations that might be associated with high seas.

Therefore, it is a further object of the present invention to enable communicating distress alerts using an omnidirectional RF antenna.

Other objects and advantages of the invention will become apparent as the description proceeds.

### PRIOR ART

U.S. application Ser. No. 11/427,993 by Pinder, assigned to Motorola, discloses Method and system for requesting help by user of communication device. Pinder discloses a transceiver capable of successively attempting to detect a communication system of the plurality of communication systems based on the predefined sequence, the transceiver accessing a satellite-based distress system when attempts to detect the communication system of the plurality of communication systems based on the predefined sequence have failed. However, Pinder fails to disclose antenna or power amplifier shared in time between data transmission to satellites and voice transmission. Pinder also fails to disclose diplexer and antenna matching circuitry, configured to share a single omnidirectional RF antenna. Pinder further fails to disclose (actually teaching the opposite) that the transmission to satellites is given priority over voice and other transmissions.

U.S. application Ser. No. 11/478,866 by Ames, assigned to General Motors, discloses Methods and system for providing routing assistance to a vehicle. Ames discloses A system comprising an in-vehicle telematics unit, comprising a location detection system and a two-way radio, but fails to disclose means to transmit distress alert signals to satellites, at said two-way radio.

U.S. Pat. No. 8,041,330 by Garin, assigned to Qualcomm, discloses Wireless device capable of producing an emergency beacon. Garin discloses A wireless device having a radio portion, the wireless device comprising: a beacon transmitter and a controller, but fails to disclose a voice transmitter, antenna or power amplifier shared in time between data transmission to satellites and voice transmission. Grin further fails to disclose share a single omnidirectional RF antenna.

U.S. Pat. No. 9,641,657 B1 by Ham et al., discloses Providing satellite communication capabilities to existing communication devices, including a common smart phone. Ham discloses a transmitter/receiver apparatus comprising Bluetooth communications electronics, a GPS receiver, a satellite communications modem; wherein said GPS receiver and said satellite communications modem sharing a single high gain helix antenna; however, Ham fails to disclose two-way radio, and fails to disclose antenna or power amplifier shared in time between data transmission to satellites and voice transmission, and also fails to disclose diplexer and antenna matching circuitry, configured to share a single omnidirectional RF antenna.

U.S. application Ser. No. 10/515,094 by Wesby discloses System and method for monitoring and control of wireless modules linked to assets. Wesby discloses means for communicating via a standard wireless telecommunication network . . . or via a satellite telecommunications system...allowing a two-way voice communication; however, fails to disclose antenna or power amplifier shared in time between data transmission to satellites and voice transmission, and also fails to disclose diplexer and antenna matching circuitry, configured to share a single omnidirectional RF antenna.

U.S. application Ser. No. 10/848,227 by Lai discloses Personal emergency locator transmitter (ELT) apparatus, comprising two-way radio with transmitter/receiver means comprising satellite radio telephone; however, Lai fails to disclose antenna or power amplifier shared in time between data transmission to satellites and voice transmission, and also fails to disclose diplexer and antenna matching circuitry, configured to share a single omnidirectional RF antenna.

U.S. application Ser. No. 18/517,125 by Kinamon et al. discloses In-Vehicle Transmissions; Kinamon discloses a multitude of RF sources connected by a diplexer, sharing a wired-based medium; however, fails to disclose two-way radio, and satellite transmitter, and omnidirectional antenna.

U.S. application Ser. No. 18/209,391 by Turner et al. discloses Multi-constellation transceiver; Turner discloses a satellite terminal comprising an antenna coupled to a plurality of modems, and radio-frequency (RF) chain that is shared among the multiple modems; however Turner fails to disclose two-way radio, voice transmitter, VHF and UHF bands, and sharing antenna matching circuit and omnidirectional antenna.

### SUMMARY OF THE INVENTION

The present invention discloses a two-way radio for maritime or terrestrial or airborne communication, with means to transmit distress alert signals to satellites orbiting around the earth, for search and rescue of people in distress. Typically, this radio comprises: a voice transmitter, a data transmitter to satellites, an RF amplifier, and an RF antenna, and according to the present invention, at least one of: RF amplifier or RF antenna, is configured to be used in time sharing by the voice transmitter, and the data transmitter to satellites. This way, the integration of the satellite transmitter (“satellite transmitter” meaning transmitter to satellites) in the two-way radio is efficient, enabling small size and low manufacturing cost, with an insignificant penalty of preventing simultaneous transmission of data and voice. In our context, “voice transmitter” means in general “narrow bandwidth transmitter”, with either voice or audio or low bit rate data baseband, while “narrow bandwidth” is typically less than 25 KHz, which is the standard channel separation in VHF marine radios. The carrier frequency employed by the two-way radio is not restricted, yet typically it's in the VHF or UHF or L-band. The modulation scheme is also not limited by the present invention, and could be, for example, analogue FM, or digital FSK. The data transmitter to satellites is typically in VHF or UHF or L-band, modulated by a low bit rate data stream, typically employing PSK or OQPSK modulation. Obviously, the full scope of the present invention is not restricted to these specific frequency bands (also known as frequency span), modulation schemes and baseband signals.

An illustration of the operational environment of a radio according to the present invention is provided in FIG. 1.

Typically, as depicted in FIG. 2, the radio according to the present invention further comprises a diplexer and antenna matching circuitry, configured to enable sharing a single omnidirectional RF antenna by the voice transmitter and the data transmitter to satellites. As a person skilled in the art may well appreciate, a diplexer is a passive device that implements frequency-domain multiplexing, and in our context “diplexer” could also mean RF switch, or more generally a tripod or tri-pod RF device or element, not necessarily a passive device but possibly actively controlled by an external signal, typically sourced by a microcontroller. An antenna matching circuit, as well known in the art, is a passive electronic circuit used to match the input impedance of an antenna to the output impedance of transmitting source(s), in order to minimize transmission power losses. The use of omnidirectional antennas, differently from directional, is advantageous for maritime use, mitigating the ship tilt, yaw and pitch, and more generally to satellite communication with non-geostationary satellites, at Low Earth Orbit (LEO) and Medium Earth Orbit (MEO), which constantly move relatively to the radio.

Further, according to the present invention, the distress alert transmission to satellites is configured to periodic and cyclic burst transmission, and disabling other radio transmissions whenever a distress alert burst is scheduled for transmission. Periodic burst transmission, e.g. a short 0.5-1 second burst every 50 seconds, is an efficient method to save power while obtaining a good probability to deliver the distress alert. In addition, the distress alert transmission is put in a higher priority than the common two-way radio transmission.

Further, according to the present invention, the time between consecutive distress alert burst transmissions is configured enabling determining the geolocation of the radio at a remote receiver, independently of GNSS. Such method is disclosed in U.S. Pat. No. 9,709,656 by Katz, and another such method is disclosed in U.S. Pat. No. 10,054,663 also by Katz.

Preferably, as depicted in FIG. 3, the voice signals are transmitted in a VHF band, and the data signals to satellites transmitted in a UHF band. Again, without restricting the full scope of the invention, the voice signals are typically transmitted in the marine VHF band of 156-174 MHz, and the satellite distress signals are typically transmitted in the 406 MHz UHF band, allocated worldwide for distress earth to space communication.

In addition, as depicted in FIG. 3 and FIG. 4, in the radio, at least one of said: voice transmitter or satellite data transmitter is further configured to transmit distress signals detectable at non-satellite receivers, such as but not restricted to: Digital Selective Calling (DSC) or Automatic Identification System (AIS) or 121.5 MHz (civilian air distress) or 243 MHz (military air distress) signals. As well known in the art, DSC and AIS are popular communication protocols employed in maritime communication to alert upon distress, in the VHF band, so could be useful at short range, inferior to the worldwide coverage of the satellite communication, but still helping in certain circumstances. DSC and AIS convey digital modulating messages, at bit rates within the voice bandwidth, so could be generated in the voice transmitter, as well as in the satellite transmitter. The 121.5/243 MHz air distress signals are respectively the civilian/military air distress signals, modulated by tones and morse code, also at low bit rate; the 121.5 MHz and 243 MHz distress transmissions are no longer detected by satellites but rather used as homing signals emitted by distress beacons, assisting the onsite rescue mainly in direction finding (DF).

Further, the two-way radio according to the present invention comprises a unified means for activating distress alert transmissions to satellites, as well as to at least one of: DSC, AIS, or the 121.5 MHz international air distress frequency. This will facilitate a user in distress to call for help, by a single button press, such that government Rescue Coordination Centers will monitor via the satellite system, as well as nearby potential rescuers.

Typically, according to the present invention, the radio further comprises a battery configured to power the distress alert transmission to satellites, but not the voice transmission. This way, choosing either a primary or a rechargeable battery, with a minimum capacity of about 3000 mAh, will ensure that upon activation, the distress alert transmission could perform for a minimum period of 24 hours.

The present invention also discloses a data transmitter, for transmission of distress alerts to satellites orbiting around the earth, configured to be embedded in a two-way radio for maritime or terrestrial or airborne communication, for search and rescue of people in distress. As depicted in FIG. 5, the data transmitter comprises: a microprocessor, a crystal oscillator (TCXO), a frequency synthesizer, and a modulator; and as depicted in FIG. 2, the data transmitter is configured to use in time sharing with other transmissions at said two-way radio, at least one of: an RF amplifier or an omnidirectional RF antenna. By using this external RF power amplifier (PA), the RF output power of the satellite transmitter is relatively low, typically about 20 dBm (100 mw), so could be implemented mainly on a single chip, actually a system on chip (SOC). Preferably, the crystal oscillator clocking the satellite transmitter is a Temperature Compensated Crystal Oscillator (TCXO), while the TCXO and frequency synthesizer are configured to generate a precise transmission frequency enabling geolocation of the radio, at a remote receiver, based on the Doppler shift caused by the orbiting speed of satellites.

Further, the transmission of distress alerts to satellites is configured to periodic and cyclic burst transmission, and configured to disable other radio transmissions whenever a distress alert burst is scheduled for transmission. As mentioned above, periodic burst transmission is an efficient method to save power while obtaining a good probability to deliver the distress alert, and periodically disabling other transmissions is done in order to increase the probability to successfully deliver the distress alert.

Preferably, the time between said periodic burst transmissions of the satellite transmitter is configured enabling determining the geolocation of the radio at a remote receiver, independently of GNSS. Employing such methods enables remote geolocation without requiring additional hardware or energy, beyond what is required to communicate the distress alert.

Finally, as shown in FIG. 4, the data transmitter is typically configured to transmit signals detectable at non-satellite receivers, such as but not restricted to Digital Selective Calling (DSC) or Automatic Identification System (AIS) or 121.5/243 MHz air distress signals. In some applications, implementing DSC or AIS or 121.5/243 MHz air distress signals, although in VHF, could be easier in this satellite transmitter, rather the voice transmitter, even if the satellite transmission is mainly in UHF.

The present invention further discloses a non-transitory computer readable storage medium having computer readable program code embodied therewith; the computer readable program code, executable by at least one processor to perform data transmission of distress alert signals to satellites orbiting around the earth, from a maritime or terrestrial or airborne two-way radio, for search and rescue of people in distress. Such computer readable storage medium is shown in FIG. 5, as a Flash memory coupled to the micro-processor. The satellite transmitter having said computer readable storage medium is depicted in FIG. 2, such that the non-transitory computer readable storage medium is part of a satellite transmitter, which in turn is part of a two-way radio comprising: a voice transmitter, a data transmitter to satellite, an RF amplifier, and an RF antenna; wherein at least one of: RF amplifier or RF antenna, is configured to be used in time sharing by the voice transmitter and the data transmitter to satellites.

Further, the non-transitory computer readable storage according to the present invention is configured to configure, for transmission of distress alert signals to satellites, at least one of: transmission frequency, modulation scheme and deviation, data bit rate, distress alert message content, RF power; wherein at least one of: RF amplifier or RF antenna at the two-way radio is configured to be used in time sharing by said voice transmitter and data transmitter to satellites.

The non-transitory computer readable storage medium is further configured to perform cyclic burst transmission of distress alerts, disabling other radio transmissions whenever a distress alert burst is scheduled for transmission.

The non-transitory computer readable storage medium is further configured to perform periodic burst transmission to satellites wherein the time between the periodic burst transmissions enabling determining the geolocation of the radio at a remote receiver, independently of GNSS.

Finally, the non-transitory computer readable storage medium is further configured to perform transmission of signals detectable at non-satellite receivers, such as but not restricted to Digital Selective Calling (DSC) or Automatic Identification System (AIS) or 121.5/243 MHz air distress signals.

### BRIEF DESCRIPTION OF DRAWINGS

The above and other characteristics and advantages of the invention will be better understood through the following illustrative and non-limitative detailed description of preferred embodiments thereof, with reference to the appended drawings, wherein:

FIG. 1—Illustration of Operational Environment of Radio according to the present invention, depicts at the bottom of the page two ships, a sailing ship at the left and a motor ship at the right; aboard each of the ships shown a two-way radio, communicating with each other, while the radio at the left ship is also shown to transmit a distress alert to a satellite illustrated at the top of the page. Then, the satellite is shown to relay the distress alert to a satellite base station, illustrated at the right side of the page.

FIG. 2—Block Diagram of Radio according to a First embodiment of the present invention, depicts two transmission paths: a voice transmission path, starting at a microphone+PTT (Press/Push To Talk), to a voice transmitter block at the middle of the page, then to a diplexer, RF amplifier, antenna matching circuit and finally to an RF antenna; a second transmission path starting at a keyboard, to a microcontroller, satellite data transmitter, to said diplexer, said RF amplifier, said antenna matching circuit and finally said RF antenna. The microcontroller is also depicted controlling the voice transmitter, and also having output to a display. A GNSS receiver, depicted at the left side of the page, is coupled to the satellite transmitter and microcontroller. Although not shown by the direction of arrows, the GNSS receiver can be controlled by the microcontroller as well. A receiving path is also shown in this picture, from the antenna to the antenna matching circuit, then to a voice receiver, and finally to a speaker.

FIG. 3—Block Diagram of Radio according to a Second embodiment of the present invention, depicts two transmission paths: a voice transmission path, starting at a microphone+PTT (Press/Push To Talk), to a VHF voice transmitter block at the middle of the page, also shown to support DSC and AIS signals, then to a diplexer, RF amplifier, antenna matching circuit and finally to an RF antenna; a second transmission path starting at a keyboard, to a microcontroller, UHF satellite transmitter, to said diplexer, said RF amplifier, said antenna matching circuit and finally said RF antenna. The microcontroller is also depicted controlling the VHF transmitter, and having output to a display. A GNSS receiver, depicted at the left side of the page, is coupled to the satellite transmitter and microcontroller. A receiving path is also shown in this picture, from the antenna to the antenna matching circuit, then to a voice receiver, and finally to a speaker.

FIG. 4—Block Diagram of Radio according to a Third embodiment of the present invention, depicts three transmission paths: a voice transmission path, starting at a microphone+PTT (Press/Push To Talk), to a voice transmitter block at the top-left side of the page, then to a diplexer, RF amplifier, [diplexer+antenna matching] and finally to an RF antenna; a second transmission path starting at a keyboard, to a satellite transmitter, shown to support also DSC/AIS+121.5 MHz transmission, to said diplexer, by two RF interfaces to support two different frequency bands, typically in VHF (DSC+AIS) and UHF (406 MHz to satellite), then to said RF amplifier, said [diplexer+antenna matching] and finally to said RF antenna; a third transmission path also starting at the keyboard, to a satellite transmitter, shown to support also DSC/AIS+121.5 MHz transmission, right to said [diplexer+antenna matching], supporting the 121.5 MHz transmission that needs no further amplification, and finally to said RF antenna; the satellite transmitter is also depicted having output to a display. A battery, depicted at the mid-left side of the page, is coupled to the satellite transmitter. A receiving path is also shown in this picture, from the antenna to the antenna matching circuit, then to a voice receiver, and finally to a speaker.

FIG. 5—Block Diagram of data transmitter to satellites according to a Fourth embodiment of the present invention, depicts a transmission path starting at a serial & discrete I/O interface, to a microprocessor coupled to a RAM and a Flash memory; then from the microcontroller the transmission path goes to a modulator, and finally to a programable RF power amplifier (PA); the modulator also having an input from a frequency synthesizer, which in turn is coupled to a Temperature Compensated Crystal Oscillator (TCXO).

### DETAILED DESCRIPTION OF THE INVENTION

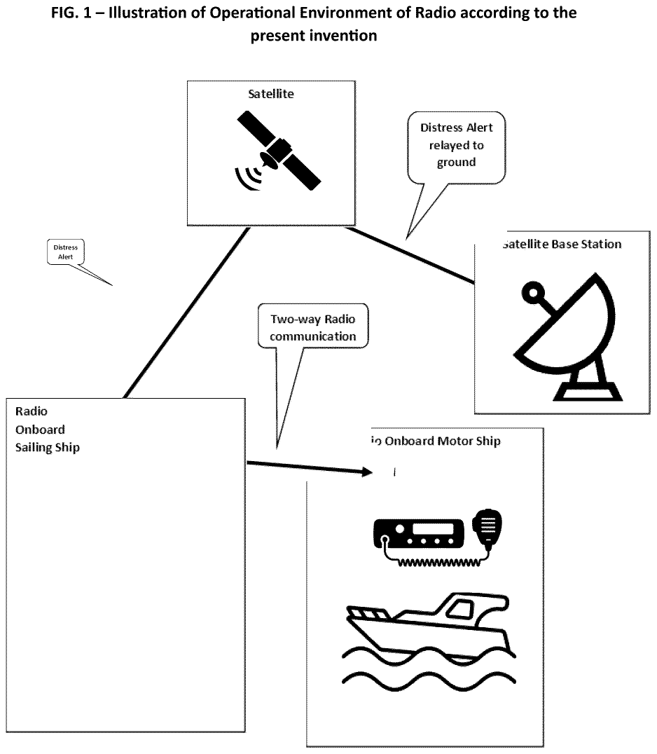

The present invention discloses a two-way radio for maritime or terrestrial or airborne communication, with means to transmit distress alert signals to satellites orbiting around the earth, for search and rescue of people in distress. An illustration of the operational environment of a radio according to the present invention is provided in FIG. 1, showing two ships, a sailing ship and a motor ship, aboard each shown a two-way radio, communicating with each other, while the radio on the left ship is also shown to transmit a distress alert to a satellite, which in turn relay the distress alert to a base station, from which, not shown, the rescue operation is launched.

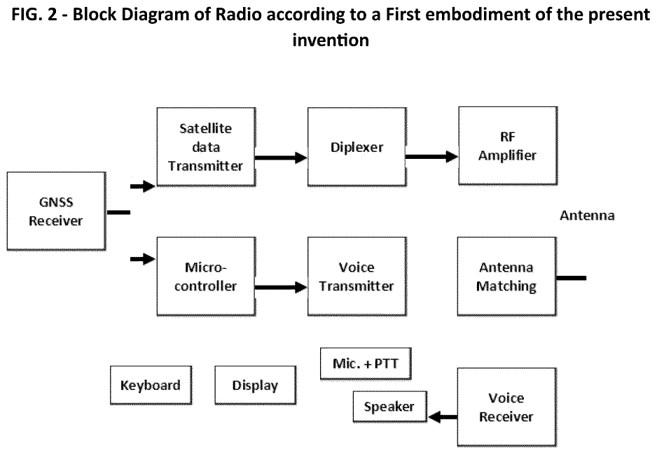

According to a first embodiment of the present invention, as depicted in FIG. 2, the radio comprises: a voice transmitter, a data transmitter to satellites, an RF amplifier, and an RF antenna; wherein at least one of: RF amplifier or RF antenna, is configured to be used in time sharing by the voice transmitter and the data transmitter to satellites. According to this first embodiment, the voice transmitter is configured to operate in the marine VHF band of 156-174 MHz, with analogue or digital baseband, employing a frequency modulation scheme of FM (for analog baseband) or FSK or GMSK (for digital baseband), or alike. The data transmitter to satellites, according to this first embodiment, is a UHF transmitter, in the 406-406.1 MHz band, employing either PSK or Direct Sequence Spread Spectrum (DSSS) OQPSK modulation. Both the voice transmitter and satellite transmitter are configured to output an RF power in the range of 20 dBm (100 mw), then the RF amplifier adding 17 dB, such that the RF transmission power routed to the antenna is about 37 dBm, i.e. 5 watts. Obviously, these numbers are representative, and could change from one application to another; nevertheless, a nominal power transmission of 5 watts is a de-facto standard in VHF marine radios, and standard in Cospas-Sarsat compatible beacons.

Typically, as depicted in FIG. 2, the radio according to the present invention further comprises a diplexer and antenna matching circuitry, configured to share a single omnidirectional RF antenna between the voice transmitter and the data transmitter to satellites. According to this first embodiment, the diplexer is configured to multiplex the VHF signal from the voice transmitter, with the UHF signals from the satellite transmitter; similarly, the antenna matching circuit is configured to match the PA output impedance with the input impedance of an omnidirectional monopole or dipole whip or helix antenna. The omnidirectional antenna is expected to have 0-3 dB gain, and radiate well at elevation angles from the horizon up to about 60 degrees. Obviously, the length of the antenna cannot equal lambda/2 or lambda/4 (lambda meaning the wavelength) of both the VHF and UHF signals, so the antenna matching circuit is configured to compensate for that; practically, a designer could choose to configure this circuit to slightly prioritize either, yet it is expected that a VHF antenna (typically longer than a UHF antenna) could better be matched also for UHF, than the opposite. Considering that the 406 MHz wavelength is app. 74 cm, and the 162 MHz wavelength is app. 185 cm, then a monopole antenna app. 20-45 cm long, or dipole antenna app. 40-90 cm long, is reasonable to be trimmed. Preferably, the antenna is rather helical than whip (meaning straight), to reduce its length.

Further, FIG. 2 depicts additional building blocks of the radio according to a first embodiment of the present invention: a microphone+PTT (Press/Push To Talk), from which the voice transmission path starts; and a microcontroller, coupled to a keyboard and display, by which the distress alert transmitter is configured to be activated. In addition, a GNSS receiver, depicted in FIG. 2, is coupled to the satellite transmitter and microcontroller, enabling inserting the radio position coordinates acquired at the GNSS receiver, to messages sent from the radio, either through the voice transmitter or the satellite transmitter. A receiving path is also shown in this picture, from the antenna to the antenna matching circuit, then to a voice receiver, and finally to a speaker. The specific nature of the VHF receiver is out of the scope of the present invention.

Still according to the first embodiment of the present invention, the distress alert transmission to satellites is configured to periodic and cyclic burst transmission, and disabling other radio transmissions whenever a distress alert burst is scheduled for transmission. Specifically, the transmission schedule is configured in compliance with the Cospas-Sarsat T.001 specifications of First-Generation Beacon (FGB), i.e. burst duration of 520 ms, transmitted every 50 s+/−2.5 s, pseudo-randomly distributed, to prevent transmission collision among radio beacons. If the radio user presses the PTT when a distress alert is scheduled for transmission to satellites, the distress alert will be transmitted, the user voice transmission will be interrupted for about 520 ms, and the user will be notified for this interruption, via the display and speaker.

Then, according to the first embodiment of the invention, the time between the distress alert periodic burst transmissions is configured enabling determining the geolocation of the radio at a remote receiver, independently of GNSS. To achieve that, the difference in time of emissions (DTOE), also known as difference in time of transmission (DTOT), although configured pseudo-randomly, is quantized, e.g. set to a multiplication of 1 ms. This will enable, at a remote receiver, determining a hyperbolic line of position (LOP) on which the radio is estimated to be placed. Several transmissions can enable determining several LOPs, and assuming a stationary or slow-moving radio, a crossing point of such LOPs could estimate the radio position.

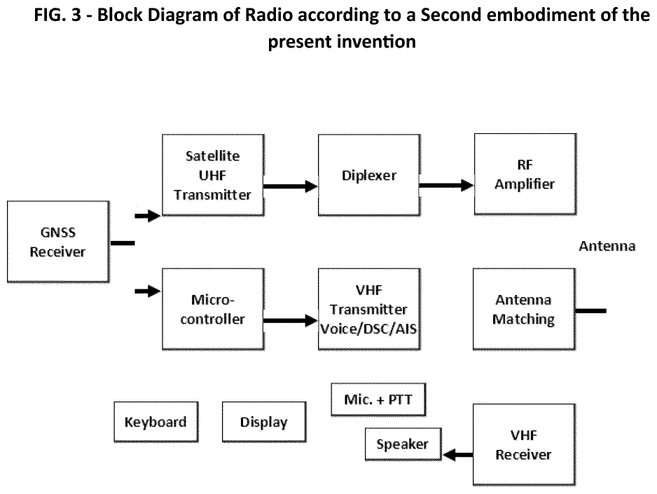

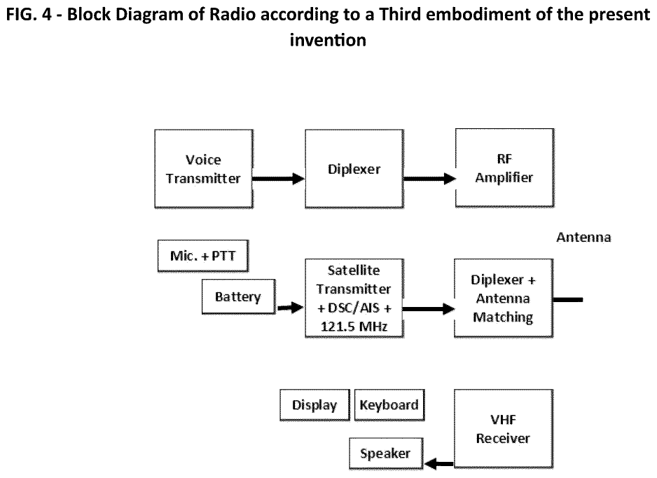

As depicted in FIG. 3 and FIG. 4, in the radio, at least one of said: voice transmitter or satellite data transmitter is further configured to transmit distress signals detectable at non-satellite receivers, such as but not restricted to Digital Selective Calling (DSC) or Automatic Identification System (AIS) or 121.5/243 MHz air distress signals.

According to a second embodiment of the present invention, and as depicted in FIG. 3, the voice signals are transmitted in a VHF band, and the data signals to satellites transmitted in a UHF band. Further, according to this second embodiment, the radio operates in the 156-174 MHz marine VHF band, with 25 KHz channel spacing. In addition, the voice transmitter is configured to transmit DSC and AIS signals. As known in the art, VHF frequencies are allocated to DSC and AIS: (circa) 156 MHz for DSC and 162 MHz for AIS. So, according to this second embodiment, the “voice transmitter” is configured to transmit also low-rate data implementing DSC and AIS protocols. The DSC employs frequency-shift keying (FSK) modulation, using two tones, at 1300 and 2100 Hz, with a symbol rate of 1200 Baud; and AIS employing GMSK modulation at 9.6 kbps. Such transmission parameters are well aligned with the marine radio standard specification: the DSC and AIS frequencies fall in the range of 156-174 MHz, and the bit rate thereof does not violate the 25 KHz channel spacing of the marine VHF radio; thus, the DSC/AIS data and the user voice could share much of the circuitry of the voice transmitter, in terms of modulation, filtering, amplification, etc., enabling compact and efficient implementation.

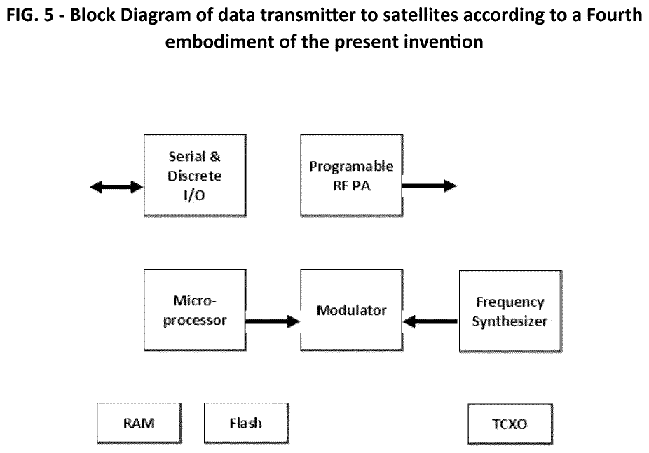

According to a third embodiment of the present invention, and as depicted in FIG. 4, the satellite transmitter is further configured to transmit DSC and AIS and 121.5 MHz distress signals. A block diagram of the satellite transmitter is shown in FIG. 5, comprising a micro-processor, modulator and frequency synthesizer. According to this third embodiment, the satellite transmitter is configured to generate the following signals:
satellite distress alert: UHF PSK modulated, at 406 MHz and 400 bps
DSC message: VHF FSK modulated, at 156 MHz and 1.2 Kbps
AIS message: VHF GMSK modulated, at 162 MHz, 9.6 Kbps
International Air Distress: 121.5 MHz modulated by 300-1600 Hz audio +1 KHz Morse

According to this third embodiment, these waveforms are generated, in a software defined radio (SDR), based on the building blocks of the satellite data transmitter shown in FIG. 5. The frequency synthesizer is configured to generate, in turn, the satellite 406 MHz, the DSC 156 MHz, the AIS 162 MHz and the air distress 121.5 MHz; then, each of these carrier frequencies is modulated, during the proper transmission, according to its standard modulated scheme: PSK, FSK, GMSK, and audio/morse respectively, at the modulator block, while the specific content of each message is generated at the micro-processor. Practically, the modulator can be part of the processor, implementing the modulation in software. Shaping of the rise time of the bits is provided by configurable filters that are part of the processor/modulator, or implemented by hardware that is not shown in FIG. 5. The modulated signals are further amplified by a programable RF PA shown in FIG. 5, typically to 20 dBm (100 mw). Then, as shown in FIG. 4, the satellite transmitter obtains a double interface to the diplexer, in the mid-top side of the page, one for the UHF satellite signal and the other for the VHF DSC and AIS, which will further be amplified to 37 dBm nominally, at the RF Amplifier; and another interface to a [diplexer+antenna matching] supporting the 121.5 MHz air distress signal that needs no further amplification.

Further, the two-way radio according to the third embodiment of the present invention comprises a unified means for activating distress alert transmissions to satellites, as well as to at least one of: DSC, AIS, or the 121.5 MHz international air distress frequency. Preferably, a button, part of the keyboard depicted in FIG. 4, implements this unified means, having some kind of physical protection to prevent inadvertent activation.
Then, upon activation, the satellite transmitter, incorporating also at least one of: DSC, AIS, or a 121.5 MHz international air distress transmitter, will coordinate and synchronize the transmission of said various signals, such that will not overlap, and comply with the respective specifications.

Since the satellite data transmitter block comprises a micro-processor, as shown in FIG. 5, the tasks of the micro-controller previously indicated with respect to a first embodiment, are implemented according to this third embodiment of the invention by the micro-processor which is part of the satellite transmitter, such that a separate micro-controller becomes redundant. Furthermore, as a person skilled in the art can well appreciate, the radio according to the present invention could employ a single micro-processor, serving the satellite transmitter needs, as well as the voice transmitter needs.

Still according to the third embodiment of the present invention, and as depicted in FIG. 4, the radio further comprises a battery configured to power the distress alert transmission to satellites, but not the voice transmission. Then, the other parts or the radio may be powered by another battery, in case of a hand-held two-way radio, or by an external power source, e.g. a ship's battery or generator, in case of a fixed mount radio. Preferably, the battery dedicated to distress alerting, is a primary lithium battery, having a nominal voltage of 3 volts, and capacity of 3000 mAh, and very low self-discharge, enabling distress alert transmission for 24 hours, at a duty cycle of about 1% (520 ms burst duration/50 s between bursts), even if the rest of the two-way radio circuitry is unpowered, and no matter how much was the voice transmission employed before activating the distress alert transmission to satellites.

The present invention also discloses a data transmitter, for transmission of distress alerts to satellites orbiting around the earth, configured to be embedded in a two-way radio for maritime or terrestrial or airborne communication, for search and rescue of people in distress. According to a fourth embodiment of the present invention, and as depicted in FIG. 5, the data transmitter comprises: a microprocessor, a crystal oscillator (TCXO), a frequency synthesizer, and a modulator; and as depicted in FIG. 2, the data transmitter is configured to use in time sharing with other transmissions at said two-way radio, at least one of: an RF amplifier or an omnidirectional RF antenna. According to this fourth embodiment, all building blocks disclosed in FIG. 5, except TCXO, are implemented using a system on chip (SOC), and programming the disclosed micro-processor. Specifically, for example, to generate a Cospas-Sarsat standard First-Generation Beacon (FGB) distress alert, the frequency synthesizer is configured to generate a 406 MHz carrier, the modulator, implemented in software, performs PSK modulation according to a distress alert message generated at the processor. The modulated signal is further amplified at an internal (in the satellite transmitter) programable RF PA shown in FIG. 5, normally to 20 dBm, and an additional 17 dB gain is provided by the external (out of the satellite transmitter, part of the two-way radio) RF amplifier, shown in FIG. 2, FIG. 3 and FIG. 4, but not shown in FIG. 5.

Further, the crystal oscillator coupled to the synthesizer, acting as a local oscillator (LO), is a Temperature Compensated Crystal Oscillator (TCXO), enabling precise transmission frequency, for accurate geolocation of the radio at a remote receiver, based on the Doppler shift caused by the orbiting speed of satellites.

Further, according to this fourth embodiment, the transmission of distress alerts to satellites is configured to periodic and cyclic burst transmission, and configured to disable other radio transmissions whenever a distress alert burst is scheduled for transmission. Specifically, according to the Cospas-Sarsat FGB standard, the distress alert bursts are transmitted every 47.5-52.5 seconds. Furthermore, the time between said periodic burst transmissions is configured enabling determining the geolocation of the radio at a remote receiver, independently of GNSS, and this is done, as disclosed before, by setting the time between consecutive bursts transmission to a multiple of 1 ms.

The present invention further discloses a non-transitory computer readable storage medium having computer readable program code embodied therewith; the computer readable program code, executable by at least one processor to perform data transmission of distress alert signals to satellites orbiting around the earth, from a maritime or terrestrial or airborne two-way radio, for search and rescue of people in distress. According to a preferred embodiment of the present invention, such computer readable storage medium is shown in FIG. 5, as a Flash memory coupled to the micro-processor. The satellite transmitter having said computer readable storage medium—Flash memory, shown in FIG. 5, is the satellite transmitter depicted in FIG. 2, FIG. 3, and FIG. 4, such that the non-transitory computer readable storage medium is part of a satellite transmitter, which in turn is part of a two-way radio comprising: a voice transmitter, a data transmitter to satellite, an RF amplifier, and an RF antenna; wherein at least one of: RF amplifier or RF antenna, is configured to be used in time sharing by the voice transmitter and the data transmitter to satellites.

Further, the program code in said non-transitory computer readable storage is configured, according to a preferred embodiment of the present invention, to set in run time, for transmission of distress alert signals to satellites, at least one of: transmission frequency, modulation scheme and deviation, data bit rate, distress alert message content, RF power; specifically, according to a preferred embodiment of the present invention, the transmission frequency is set to 406 MHz, the modulation scheme to PSK, the deviation to 1.1 rad, the data bit rate to 400 bps, in compliance to the Cospas-Sarsat T.001 standard.

The non-transitory computer readable storage medium is further configured to configure cyclic burst transmission of distress alerts, disabling other radio transmissions whenever a distress alert burst is scheduled for transmission. Preferably, the program code is configured to set in run time, the time between distress alert transmissions to 47.5-52.5 s, disabling other radio transmissions, including voice, DSC and AIS, for at least 520 ms whenever a distress alert burst is scheduled for transmission.

The non-transitory computer readable storage medium is further configured to set the time between said periodic burst transmissions enabling determining the geolocation of the radio at a remote receiver, independently of GNSS. Preferably, the program code is configured to set in run time, the time between periodic burst transmissions to an integer multiple of 1 ms, enabling determining at a remote receiver, a hyperbolic Line of Position (LOP) on which the radio is placed.

Finally, the non-transitory computer readable storage medium is further configured to perform transmission of signals detectable at non-satellite receivers, such as but not restricted to Digital Selective Calling (DSC) or Automatic Identification System (AIS) or 121.5/243 MHz air distress signals. According to a preferred embodiment of the present invention, the DSC and AIS and 121.5 MHz modulation is performed in software, by a program code stored in a Flash memory, depicted in FIG. 5.

1. A two-way radio for maritime or terrestrial or airborne communication,
with means to transmit distress alert signals to satellites orbiting around the earth, for search and rescue of people in distress; said radio comprising:
a voice transmitter
a data transmitter to satellites
an RF amplifier
an RF antenna;
wherein at least one of said: RF amplifier or RF antenna, is configured to be used in time sharing by: the voice transmitter and the data transmitter to satellites.

2. The radio according to claim 1, further comprising a diplexer and antenna matching circuitry, configured to share a single omnidirectional RF antenna by the voice transmitter and the data transmitter to satellites.

3. The radio according to claim 1, wherein said distress alert transmission to satellites is configured to periodic and cyclic burst transmission, and disabling other radio transmissions whenever a distress alert burst is scheduled for transmission.

4. The radio according to claim 3, wherein the time between said periodic burst transmissions is configured enabling determining the geolocation of the radio at a remote receiver, independently of GNSS.

5. The radio according to claim 1, wherein the voice signals are transmitted in a VHF band, and the data signals to satellites transmitted in a UHF band.

6. The radio according to claim 1, wherein at least one of said: voice transmitter or satellite data transmitter is further configured to transmit distress signals detectable at non-satellite receivers, at least one of: Digital Selective Calling (DSC) or Automatic Identification System (AIS) or the 121.5 MHz International Air Distress.

7. The radio according to claim 6, further comprising a unified means for activating distress alert transmissions to satellites, as well as to at least one of: DSC, AIS, or the 121.5 MHz international air distress frequency.

8. The radio according to claim 1, further comprising a battery configured to power the distress alert transmission to satellites, but not the voice transmission.

9. A data transmitter, for transmission of distress alerts to satellites orbiting around the earth, configured to be embedded in a two-way radio for maritime or terrestrial or airborne communication, for search and rescue of people in distress; said data transmitter comprising:
a microprocessor
a crystal oscillator
a frequency synthesizer
a modulator;
and configured to use in time sharing with other transmissions at said two-way radio, at least one of: an RF amplifier or an omnidirectional RF antenna.

10. The data transmitter according to claim 9, said crystal oscillator being a Temperature Compensated Crystal Oscillator (TCXO), said TCXO and frequency synthesizer configured to generate a precise transmission frequency enabling geolocation of the radio, at a remote receiver, based on a Doppler shift caused by the orbiting speed of satellites.

11. The data transmitter according to claim 9, wherein said transmission of distress alerts to satellites is configured to periodic and cyclic burst transmission, and configured to disable other radio transmissions whenever a distress alert burst is scheduled for transmission.

12. The data transmitter according to claim 11, wherein the time between said periodic burst transmissions is configured enabling determining the geolocation of the radio at a remote receiver, independently of GNSS.

13. The data transmitter according to claim 9, further configured to transmit signals detectable at non-satellite receivers, at least one of: Digital Selective Calling (DSC) or Automatic Identification System (AIS) or the 121.5 MHz International Air Distress.

14. The data transmitter according to claim 9, configured to the 406 MHz band, in compatibility with the Cospas-Sarsat search and rescue satellite system.

15. A non-transitory computer readable storage medium having computer readable program code embodied therewith; the computer readable program code, executable by at least one processor to perform data transmission of distress alert signals to satellites orbiting around the earth, from a maritime or terrestrial or airborne two-way radio, for search and rescue of people in distress; said two-way radio comprising:
a voice transmitter
a data transmitter to satellite
an RF amplifier
an RF antenna;
and wherein at least one of said: RF amplifier or RF antenna, is configured to be used in time sharing by the voice transmitter and the data transmitter to satellites.

16. The non-transitory computer readable storage according to claim 15, configured to set at least one of:
transmission frequency
modulation scheme and deviation
data bit rate
distress alert message content
RF power;
associated with said distress alert signals to satellites.

17. The non-transitory computer readable storage medium according to claim 15, configuring the transmission of the distress alerts to cyclic burst transmission, and disabling other radio transmissions whenever a distress alert burst is scheduled for transmission.

18. The non-transitory computer readable storage medium according to claim 15, further configuring the time between said periodic burst transmissions enabling determining the geolocation of the radio at a remote receiver, independently of GNSS.

19. The non-transitory computer readable storage medium according to claim 15, further configured to perform transmission of signals detectable at non-satellite receivers, at least one of: Digital Selective Calling (DSC) or Automatic Identification System (AIS) or 121.5/243 MHz Air Distress alerts.

20. The non-transitory computer readable storage medium according to claim 15, configured to perform transmission of distress alert signals to satellites in the 406 MHz band.
